(19) United States
(12) Patent Application Publication
(10) Pub. No.: US 2008/0186178 A1
(43) Pub. Date: Aug. 7, 2008

(54) RFIDS, interrogators, indication systems, methods of determining a bi-directional communication range of an interrogator, methods of activating an observable indicator, and methods of indicating bi-directional functionality of a radio connection

(75) Inventors: John R. Tuttle, Boulder, CO (US); Mark E. Tuttle, Boise, ID (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Micron Technology, Inc.

(21) Appl. No.: 11/704,516

(22) Filed: Feb. 7, 2007

(51) Int. Cl. G08B 7/06

(52) U.S. Cl. 340/572.1

(57) ABSTRACT

Some embodiments includes RFIDs capable of activating an observable indicator upon receiving an indicate signal. Some embodiments includes RFIDs capable of activating an observable indicator based on a position of a manually operated switch. Some embodiments include interrogators capable of verifying a radio connection prior to sending an indicate signal to an RFID. Some embodiments include indication systems. Some embodiments include methods of determining a bi-directional communication range of an interrogator. Some embodiments include re-assessing a bi-directional communication range of an interrogator subsequent to an environment change. Some embodiments include methods of activating an observable indicator based on the position of a manually operated switch. Some embodiments include methods of indicating bi-directional functionality of a radio connection with an observable indicator of an RFID.

### TECHNICAL FIELD

Radio frequency identification devices (RFIDs), interrogators, indication systems, methods of determining a bi-directional communication range of an interrogator, methods of activating an observable indicator, and methods of indicating bi-directional functionality of a radio connection.

### BACKGROUND

RFIDs have numerous uses, including, for example, inventory tracking.

RFIDs are utilized in systems with interrogators. The interrogators communicate with the RFIDs through radio frequency (RF) signals. The RFIDs may be either active devices or passive devices. Active devices have their own power sources, and passive devices rely solely on power from RF signals sent by the interrogators.

Active devices have an advantage in that they may be utilized further from an interrogator than passive devices, but have the disadvantage that the power source within the active devices has a limited lifespan. Also, active devices may be more expensive than passive devices. Accordingly, passive devices and active devices each have advantages and disadvantages that may render one type of device more suitable for a particular application than the other.

Interrogators send signals to RFIDs on a forward link of a radio channel. RFIDs may send signals to interrogators on a return link of the radio channel. Due to link budget and propagation differences between these two links, an RFID within a forward link range of an interrogator may not necessarily be within a return link range of the interrogator.

### BRIEF DESCRIPTION OF THE DRAWINGS

FIG. 1 is a diagrammatic view of an RFID embodiment.

FIG. 2 is a block diagram of circuitry of a passive RFID embodiment.

FIG. 3 is a block diagram of circuitry of an active RFID embodiment.

FIG. 4 is a block diagram of circuitry of an interrogator embodiment.

FIG. 5 is a diagram of a wireless communication system embodiment.

FIG. 6 illustrates a method of indicating bi-directional functionality of a radio connection.

FIG. 7 is a diagram of another wireless communication system embodiment.

FIG. 8 is a diagram of a wireless communication system for determining a bi-directional communication rage of an interrogator.

FIG. 9 is a diagram of another wireless communication system for determining a bi-direction communication range of an interrogator.

FIG. 10 is a diagram a wireless communication system of FIG. 9 subsequent to adding an obstacle to the system.

FIG. 11 is a diagrammatic view of another RFID embodiment.

FIG. 12 is a block diagram of circuitry of another passive RFID embodiment.

FIG. 13 is a diagram of another wireless communication system embodiment.

### DETAILED DESCRIPTION OF THE ILLUSTRATED EMBODIMENTS

Various systems and methods are disclosed for incorporating observable identifiers into RFIDs. The observable identifiers may be utilized for determining which RFIDs with a group of RFIDs are interrogated by a particular interrogator. In some embodiments, the observable indicators may be a single ON/OFF visual indicator area on an RFID tag that may serve as an indicator that an interrogator is presently communicating with that tag by its ID number. Alternatively, or additionally, multiple ON/OFF visual indicator areas on an RFID tag may serve as an indicator that an interrogator is presently communicating with that tag by its ID number.

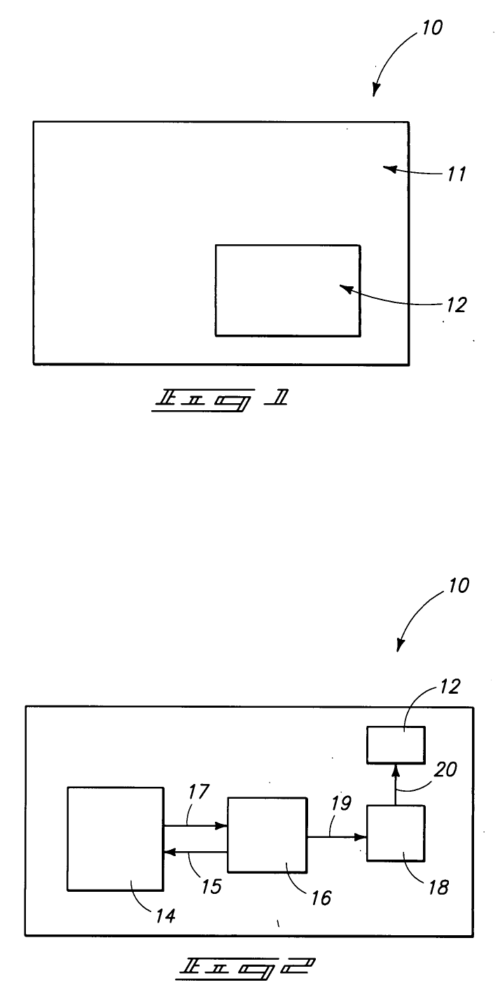

An example of a radio frequency identification device (RFID) having an observable indicator associated therewith is shown in FIG. 1 as device 10. The device 10 comprises a surface 11. An observable indicator region 12 is shown formed along a portion of such surface. Although the depicted observable indicator comprises only a portion of surface 11, in other embodiments the observable indicator region may comprise the entirety of surface 11.

The observable indicator 12 may comprise one or more compositions that may be modified some selected characteristic so that a change in the observable indicator is perceptible to a person. Such change may be a change in color, and/or a change in an observed pattern. Suitable compositions for utilization in the observable indicator 12 are compositions that create visible changes upon being subjected to electrical power. For example, the observable indicator 12 may be one or more light-emitting diodes (LEDs).

It may be preferred that the visible changes be induced with very little power input. For instance, if RFID 10 is a passive device, there will be little power available to cause a change. Alternatively, if RFID 10 is an active device, there will be more power, but it may still be preferred that little power be utilized to change observable properties within the observable indicator so that change may be conserved within the power reservoir of the active device.

In some applications, very low power electronic displays (which may be referred to as zero-power electronic displays if the displays convey information in the absence of power) are utilized within the observable indicator. Very low power displays may be particularly useful for passive RFIDs, since passive RFIDs have little power available with which to activate an observable indicator. Passive RFIDs get all of their power from an interrogator's electromagnetic field, and thus are generally not powered (except for a little charge remaining on a power supply capacitor) when an interrogator field is absent. Thus, if an observable indicator is going to maintain a perceptible change state, such as a visible pattern, in the absence of an interrogator's electromagnetic field, such should occur with zero power. Examples of zero-power display technologies are electronic ink, electronic paper, ferroelectrics, and polymer electrochromics. For instance, Nemoptic of France manufactures various zero power display materials.

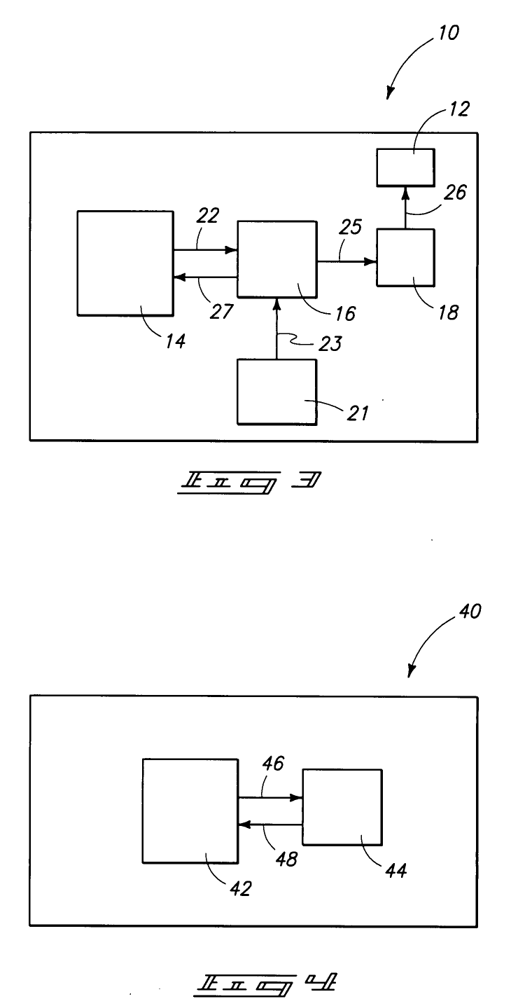

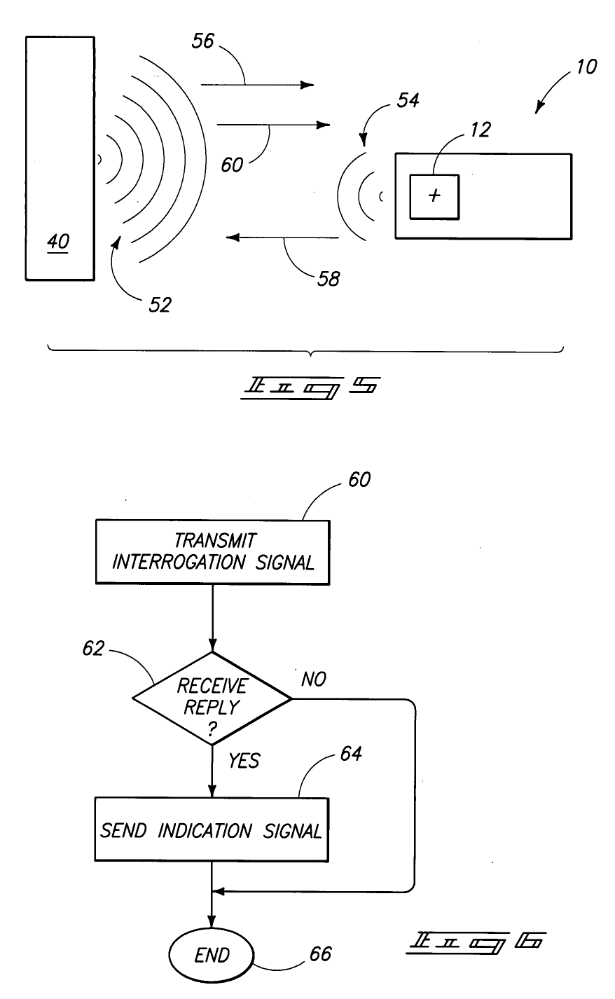

FIGS. 2 and 3 show embodiment circuit configurations suitable for passive RFIDs having observable indicators.

Referring first to FIG. 2, such shows an embodiment of RFID 10 comprising an antenna 14, communication circuitry 16, indication circuitry 18, and the observable indicator 12. Indication circuitry 18 is configured to selectively activate observable indicator 12.

Communication circuitry 16 is configured to send a reply signal via a radio connection in response to an interrogation signal received via the radio connection. Communication circuitry 16 is further configured to receive an indicate signal sent by an interrogator in response to the reply signal. After receiving the indicate signal, communication circuitry 16 enables indication circuitry 18 to activate observable indicator 12.

Communication circuitry 16 may receive a continuous wave interrogation signal via antenna 14 on a forward link of the radio connection. Communication circuitry 16 may be configured to respond by backscatter modulating the continuous wave interrogation signal and sending the backscatter modulated continuous wave interrogation signal to the interrogator via antenna 14 on a return link of the radio connection.

In operation, a signal received by RFID 10 creates power in antenna 14. Such power is directed to communication circuitry 16 along the path diagrammatically illustrated by arrow 17. FIG. 2 also shows power flow from communication circuitry 16 to antenna 14 along a path 15. The flow along path 15 enables RFID 10 to send information out to a receiving device, in addition to receiving an signal from an interrogator. The receiving device may be the same as the interrogator that sent communication to the RFID, or may be different.

One way communication circuitry 16 may selectively enable indication circuitry 18 is by controlling the flow of power to indication circuitry 18. A portion of the power reaching communication circuitry 16 may be directed from communication circuitry 16 to indication circuitry 18 along the path diagrammatically illustrated by arrow 19.

Communication circuitry 16 may be configured to allow power to flow to indication circuitry 18 after receiving an indicate signal from an interrogator via antenna 14. Upon receiving power, indication circuitry 18 may activate the observable indicator.

Communication circuitry 16 may use other ways of selectively enabling the indication circuitry 18. For example, communication circuitry 16 may change the state of an enable line connecting communication circuitry 16 to indication circuitry 18, send a message to indication circuitry 18, or use other techniques well known to those of skill in the art.

Indication circuitry 18 may be configured to selectively activate the observable indicator when indication circuitry 18 is enabled by communication circuitry 16. For example, indication circuitry 18 may be a simple circuit that relays power received from the communication circuitry to an LED.

Observable indicator 12 may comprise a substance that changes in some characteristic visible to a person observing the observable indicator when the observable indicator is activated. The visible change may include, for example, one or any of a color change, contrast change and pattern change. The indication circuitry 18 may be characterized as visual indication circuitry. Such visual indication circuitry may be configured to respond to power input by altering a visual identifier observable by a person looking at the observable indicator 12 (FIG. 1) of RFID 10.

The observable indicator may show a pattern or other indication that lasts about as long as power is supplied to the RFID, or may change to a stable display that remains in its altered state for at least some extended period in the absence of power to the RFID.

Notably, the RFID of FIG. 2 comprises only one antenna. Such antenna is configured to power communication circuitry 16, indication circuitry 18, and observable indicator 12. Alternatively, the RFID may include two antennas, one used to receive signals and one used to transmit signals.

FIG. 2 depicts an embodiment of a passive RFID, but observable indicator techniques may also be utilized with active RFIDs. FIG. 3 shows an embodiment of an RFID 10, which is an active RFID.

The RFID of FIG. 3 comprises the antenna 14, communication circuitry 16, and identification circuitry 18 discussed above; and further comprises a power source 21. The power source 21 may comprise, for example, a battery.

Power from the battery is shown by arrow 23 as being utilized to power communication circuitry 16. Power may then directed from communication circuitry 16 to identification circuitry 18, as shown by arrow 25 and then to the observable indicator 12, as shown by arrow 26. Further, power may be directed from communication circuitry 16 to antenna 14, as designated by arrow 27.

The active RFID of FIG. 4 may be utilized alternatively to the passive RFID of FIG. 2, or in addition to the passive RFID.

In the discussion of FIGS. 1-3, observable indicator 12 is described as a visual observable indicator. It is to be understood, however, that other user-observable characteristics may be used in some embodiments. The other user-observable characteristics may be any characteristics that may be sensed by a person proximate the RFID (such as sound or touch). However, characteristics other than visual characteristics, such as audible characteristics, may utilize more power than the visual characteristics, and may be more difficult to quickly and accurately locate. Thus, it may be desirable to use visual characteristics.

FIG. 4 depicts an embodiment of an interrogator 40. The interrogator includes at least one antenna 42 and communication circuitry 44. Antenna 42 is configured to send and receive signals vis a radio connection.

Communication circuitry 44 is configured to transmit an interrogation signal to an RFID via the radio connection. The interrogation signal is sent on link 48 to antenna 42. Communication circuitry 44 also receives reply signals sent by an RFID via the radio connection. The RFID may send these reply signals in response to the interrogation signal sent by the interrogator. Communication circuitry 44 may receive the reply signal from antenna 42 on link 46.

Communication circuitry 44 is also configured to send an indicate signal on the radio connection to an RFID via link 48 and antenna 42 in response to receiving a reply signal. The indicate signal is configured to instruct the RFID to activate an observable indicator. Communication circuitry 44 may be configured to determine that the radio connection is operational before sending the indicate signal to the RFID.

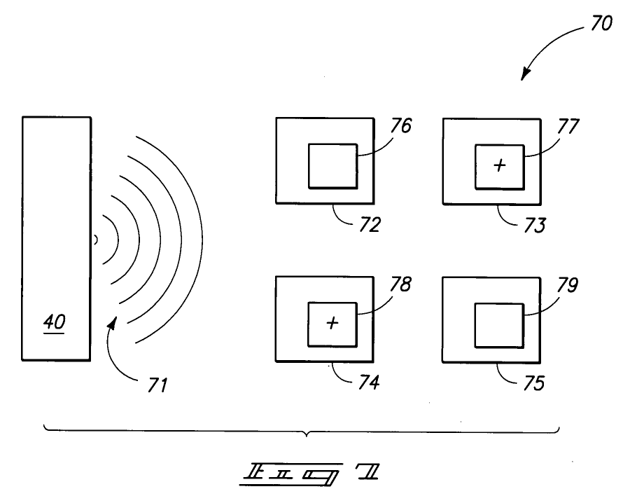

FIG. 5 depicts a system for communication between an interrogator and an RFID. The system includes an interrogator 40, an RFID 10, and a radio connection made up of a forward link 52 and a return link 54. Interrogator 40 transmits signals to RFID 10 on forward link 52 of the radio connection. RFID 10 may send signals to interrogator 40 on return link 54 of the radio connection.

Although forward link 52 and return link 54 may share the same frequency or may have other features in common, forward link 52 and return link 54 may have different propagation characteristics. The range of forward link 52 may be determined by factors such as a power level at which interrogator 40 transmits, a type of antenna used by interrogator 40, and a location of the antenna.

Return link 54 may have a different range than forward link 52 because the factors that determine the return link range may be different from the factors that determine the forward link range. The factors that determine the return link range may include a power level at which RFID 10 transmits and a type of antenna used by RFID 10. If, for example, RFID 10 transmits at a lower power level than interrogator 40, return link 54 may have a smaller range than forward link 52.

Since forward link 52 and return link 54 may have different ranges, when RFID 10 is placed in a particular location, RFID 10 may successfully receive signals from interrogator 40 on forward link 52. However, interrogator 40 might not successfully receive signals from RFID 10 on return link 54. Similarly, in some situations, interrogator 40 may successfully receive signals from RFID 10 on return link 54, but RFID 10 might not successfully receive signals from interrogator 40 on forward link 52.

It is advantageous, therefore, to determine a reliable communication range of a radio channel over which signals may be reliably received by an RFID on a forward link of the radio channel and by an interrogator on a return link of the radio channel. FIG. 5 illustrates a flow of signals that determine whether an RFID is within a reliable communication range of an interrogator.

First, interrogator 40 transmits an interrogation signal 56 via forward link 52 to RFID 10. Interrogation signal 56 may request that any RFID within forward link range of interrogator 40 reply to interrogation signal 56. Alternatively, interrogation signal 56 may request that only one or more RFIDs specifically identified by interrogation signal 56 reply to interrogation signal 56. Interrogator 40 might not know whether any RFIDs are within range prior to transmitting interrogation signal 56.

If RFID 10 successfully receives interrogation signal 56., RFID 10 is within range of interrogator 40 with respect to forward link 52. In response to interrogation signal 56, RFID 10 sends a reply signal 58 on return link 54. Reply signal 58 may contain a field that uniquely identifies RFID 10. If interrogator 40 successfully receives reply signal 58, RFID 10 is within range of interrogator 40 with respect to return link 54.

Once interrogator 40 has received reply signal 58, it may determine that RFID 10 is within range of interrogator 40 with respect to both forward link 52 and return link 54. This determination may supported by the fact that interrogator 40 correctly received reply signal 58 on return link 54 and by the fact that RFID 10 would not have sent reply signal 58 if RFID 10 had not properly received interrogation signal 56 on forward link 52. This determination may be even more likely to be correct if interrogation signal 56 was addressed exclusively to RFID 10.

Since RFID 10 is within range, interrogator 40 may send an indicate signal 60 on forward link 52 to RFID 10. Indicate signal 60 is configured to instruct RFID 10 to activate observable indicator 12. In the system depicted in FIG. 5, the activated observable indicator 12 is depicted with a “+” sign. Consequently, someone noticing observable indicator 12 may conclude that RFID 10 is within range of interrogator 40 with respect to both forward link 52 and return link 54.

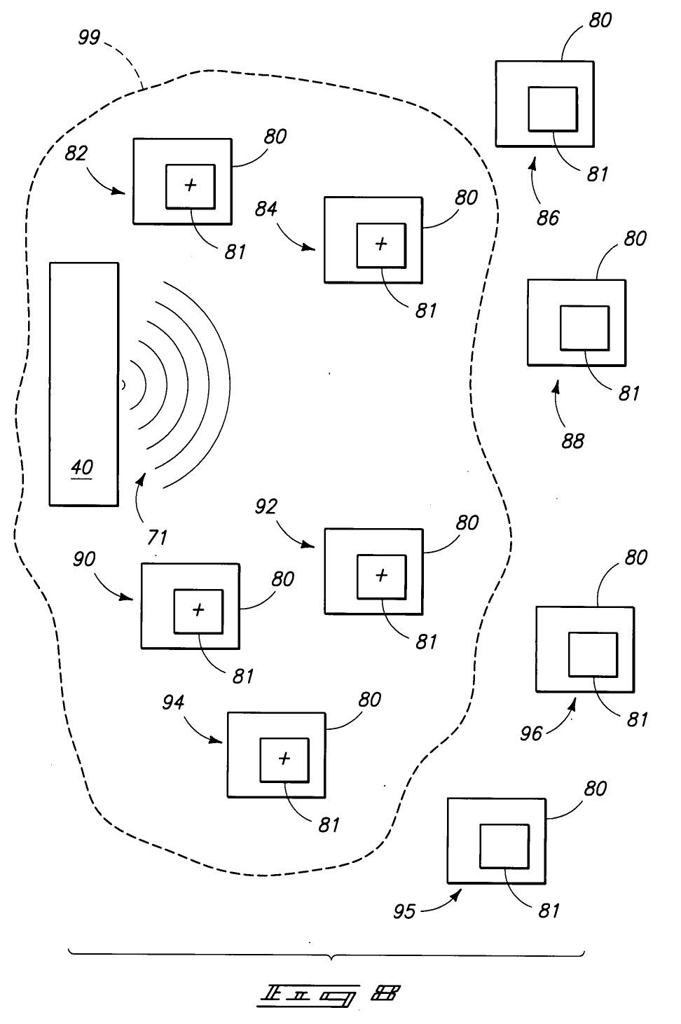

FIG. 6 depicts a method that may be used by an interrogator to verify the bi-directional functionality of radio connection. At 60, the interrogator transmits an interrogation signal on a forward link of the radio connection. As was discussed able in relation to FIG. 5, the interrogation signal may be addressed to one or more RFIDs in particular, rather than being generally addressed to any RFID. Alternatively, the interrogation signal may be addressed exclusively to one RFID.

An RFID may receive the interrogation signal from the interrogator. If the RFID determines that the interrogation signal contains a request that the RFID respond to the interrogation signal, the RFID relies to the interrogation signal by sending a reply signal on a return link of the radio connection. The reply signal may contain a field that identifies the RFID that sent the reply signal.

At 62, the interrogator determines whether it has received a reply to the interrogation signal. If the interrogator receives a reply signal in response to the interrogation signal, the interrogator, at 62, sends an indicate signal to the RFID on the forward link.

The indicate signal is configured to instruct the RFID to activate its observable indicator. The activation of the observable indicator indicates the bi-directional functionality of the radio connection since the interrogator has successfully sent an interrogation signal on the forward link and received a reply signal on the return link.

One the RFID has received an indicate signal, the RFID activates its observable indicator. The RFID may continue to activate its observable indicator until instructed otherwise. In this case, the interrogator may send a discontinue indicate signal to the RFID on the forward link that instructs the RFID to deactivate the observable indicator. The interrogator may send the discontinue indicate signal a predetermined amount of time after sending the indicate signal.

This functionality may be helpful, for example, when a user wants to observable indicator to be observable long enough for the user to detect that the observable indicator has been activated. For example, a predetermined amount of time of five to ten seconds may be enough to allow the user to notice that the RFID has activated the observable indicator.

Of course, this approach may not be efficient for a passive RFID that might not have enough power to activate the observable indicator for an extended period of time. However, if an observable indicator is able to stay activated for a period of time without consuming power, this approach may still be effective for a passive RFID.

Alternatively, the indicate signal may be configured to instruct the RFID to activate the observable indicator for a predetermined amount of time, after which, the RFID de-actives the observable indicator without having to receive an additional signal from the interrogator.

Alternatively, the indicate signal may be configured to instruct the RFID to activate the observable indicator for a predetermined amount of time. The predetermined period amount time may be specified by a portion of the indicate signal.

For example, the predetermined amount of time may be specified in a command portion of the indicate signal using one or more bits. The RFID receives the indicate signal, parses the signal for the predetermined amount of time, and then activates the observable indicator. It may also start a timer having a value of the predetermined amount of time, and de-active the observable once the timer expires.

Returning now to FIG. 6, if the interrogator does not receive a reply at 62 the interrogator determines that the radio connection is not bi-directionally functional and the method ends 66. The method of FIG. 6 may be repeated until the interrogator does receive a reply signal.

The RFIDs of FIGS. 1-3 may be utilized in inventory or other object tracking systems. FIG. 7 illustrates a tracking system 70 that includes an interrogator 40 and plurality of RFIDs 72, 73, 74, and 75. RFIDs 72, 73, 74, and 75 comprises observable indicators 76, 77, 78, and 79, respectively.

Interrogator 40 transmits a radio frequency interrogation signal on radio connection 72 toward RFIDs 72, 73, 74, and 75. The interrogation signal, in this embodiment, is addressed to RFIDs 73 and 74 but not to RFIDs 72 and 75. In response to receiving the interrogation signal, RFIDs 73 and 74 reply to the interrogator with a reply signal. The interrogator, upon receiving the reply signals from RFIDs 73 and 74, sends an indicate signal to RFIDs 73 and 74.

RFIDs 73 and 74 are shown to have a “+” (i.e., a plus sign) formed in observable indicators 77 and 78, while RFIDs 72 and 75 do not have any symbols in the observable indicators thereof. The system of FIG. 7 may be used for determining whether particular RFIDs are within a range of the interrogator.

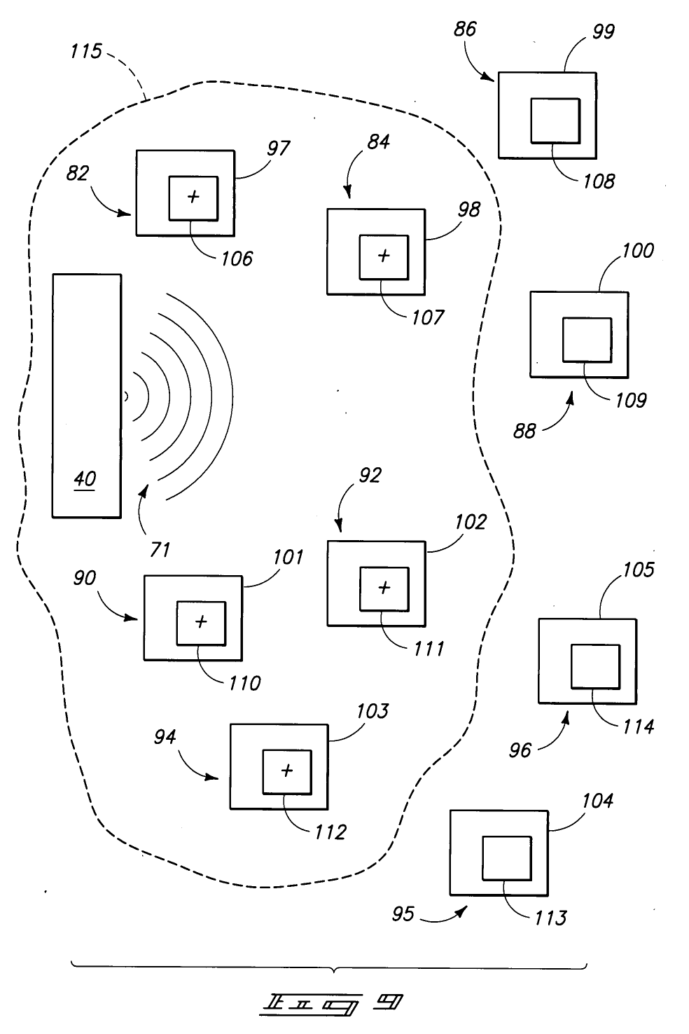

FIG. 8 depicts a system configured to use an interrogator and an RFID to determine the reliable communication range of the interrogator. An interrogator 40 is configured to send an interrogation signal on a radio connection 71 requesting that a particular RFID, RFID 80, respond to the interrogation signal. Interrogator 40 may use the method of FIG. 6 to determine whether to send the RFID 80 an indicate signal.

RFID 80 includes an observable indicator 81. RFID 80 may be moved to a plurality of locations 82, 84, 86, 88, 90, 92, 94, 95, and 96. In each location, interrogator 40 sends an interrogation signal to RFID 80 and waits for a reply signal. If interrogator 40 receives a reply signal from RFID 80, interrogator 40 sends an indicate signal to RFID 80. At each location, a user may classify the location as being within a range of interrogator 40 if observable indicator 81 is activated at the location due to an indicate signal. If observable indicator 81 is not activated at the location, the user may classify the location as being outside the range.

In performing this method, it may be helpful to configure interrogator 40 and/or RFID 80 so that observable indicator 81 remains activated long enough for the user to determine whether observable indicator 81 has been activated. However, observable indicator 81 should be not activated long enough that the user may move RFID 80 to a new location and erroneously conclude that the new location is within the range because observable indicator 81 is still activated due to the indicate signal received at the prior location.

Consequently, in performing this method, the user may need to remain at a particular location until observable indicator 81 has been either activated and subsequently deactivated or not activated at all. This ensures that the user will not erroneously think that a particular location is with the range.

FIG. 8 depicts observable indicator 81 of RFID 80 being activated in locations 82, 84, 90, 92, and 94. Accordingly, these locations are within a bi-directional range 99 of interrogator 40. Since observable indicator 81 of RFID 80 is not activated in locations 86, 88, 95, and 96, these locations are not within range 99 of interrogator 40.

This method may be useful in helping a user determine the reliable communication range of an interrogator subsequent to installing the interrogator. This method is efficient since it allows a single user to determining whether a particular location is within range by simple looking at the RFID. The user need not interact with an interrogator, for example by pressing a button on the interrogator for each location in which the RFID is placed or watching the interrogator for range feedback at each location.

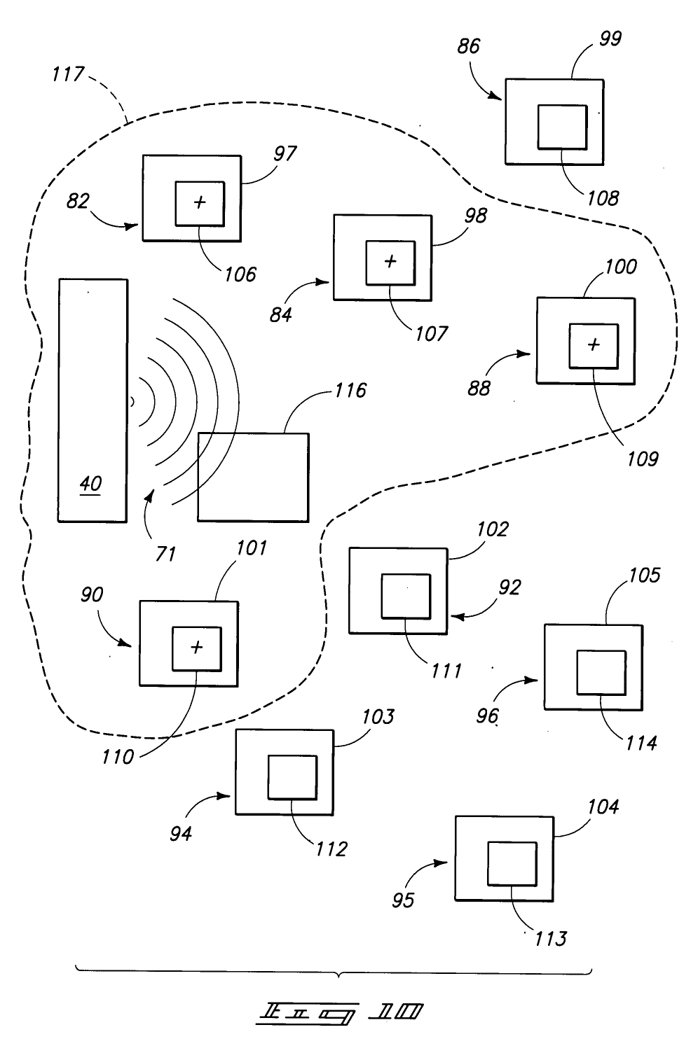

FIG. 9 depicts an alternative system for determining the range of interrogator 40. According to this method, RFIDs 97, 98, 99, 100, 101, 102, 103, 104, and 105 may be placed respectively in locations 82, 84, 86, 88, 90, 92, 94, 95, and 96. Each of the RFIDs includes an observable indicator 106, 107, 108, 109, 110, 111, 112, 113, and 114.

Interrogator 40 sends an interrogation signal configured to instruct all of the RFIDs to reply with a reply signal. The RFIDs of FIG. 9 that are within a forward link range of a radio connection 71 of interrogator 40 respond to the interrogation signal with a reply signal. Interrogator 40 then sends an indicate signal to each of the RFIDs from which it receives a reply signal. Consequently, those RFIDs that receive an indicate signal activate their observable indicators.

In FIG. 9, RFIDs 97, 98, 101, 102, and 103 receive an indicate signal and activate their observable indicators 106, 107, 110, 111, and 112. Accordingly, these RFIDs are within a bi-directional range 115 of interrogator 40. RFIDs 99, 100, 104, and 105 do not receive an indicate signal and therefore do not activate their observable indicators 108, 109, 113, and 114. Accordingly, these RFIDs are not within the bi-directional range 115.

Of course, the bi-directional range of an interrogator may change dynamically as the environment around the interrogator changes. If an obstacle is placed within the range of the interrogator, the propagation of the interrogator's forward link signal may be affected. For example, a large metal object may reflect the forward link or change the way that the forward link propagates. It may be helpful to assess changes in the range of the interrogator as obstacles become part of the environment of the interrogator. FIG. 10 illustrates a method of determining the range of an interrogator after an obstacle has come into the forward link range of the interrogator.

In FIG. 10, an obstacle 116 has been placed near interrogator 40. Obstacle 116 may be a large metal object or may be some other object capable of changing the propagation of the forward link signal transmitted by the interrogator. As result of obstacle 116, the forward link propagation changes so that RFIDs 102 and 103, which were previously within range 115, are no longer in range 115. These RFIDs may no longer by within range because they did not reliably received the interrogation signal or because they did receive the interrogation signal but their reply signals were not reliably received by interrogator 40. A bi-directional range 117 resulting from the obstacle 116 is depicted as a dashed line.

In addition, RFID 100, which was not previously within range 115, is now within range 117 as indicated by the fact that observable indicator 109 is activated. This may be due to a change in propagation introduced by obstacle 116. For example, obstacle 116 may reflect the forward link in such a way that RFID 100 may now reliably receive a reflected version of the forward link.

In some situations, an embodiment of an RFID that allows for manual control of an observable indicator may be desirable.

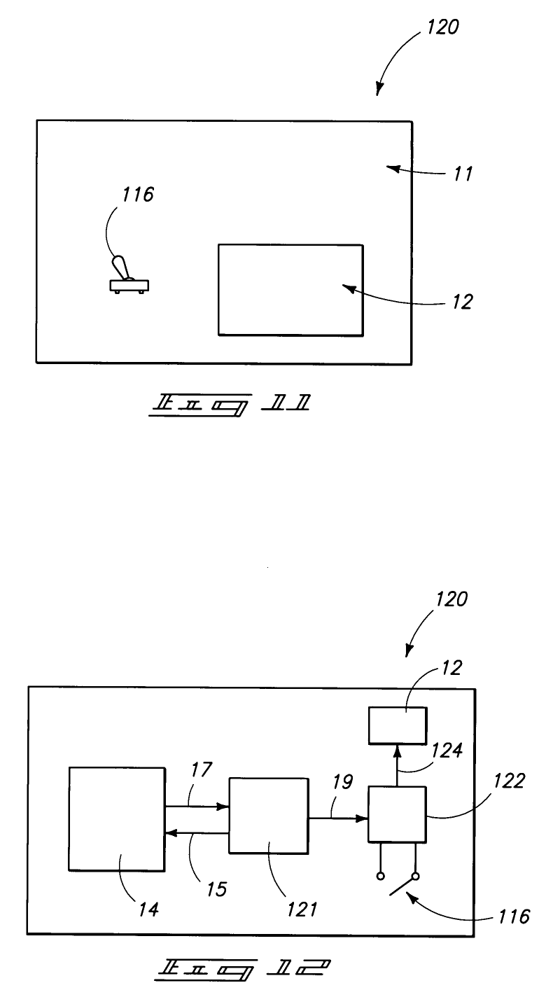

FIG. 11 illustrates another embodiment of an RFID 120. The RFID includes the surface 11 and observable indicator 12 of FIG. 1 as well as a manually operated switch 116. Manually operated switch 116 is configured to switch between an enabled position and a non-enabled position. For example, the enabled position may be a position in which the manually operated switch 116 is closed and the non-enabled position may be a position in which the manually operated switch 116 is open.

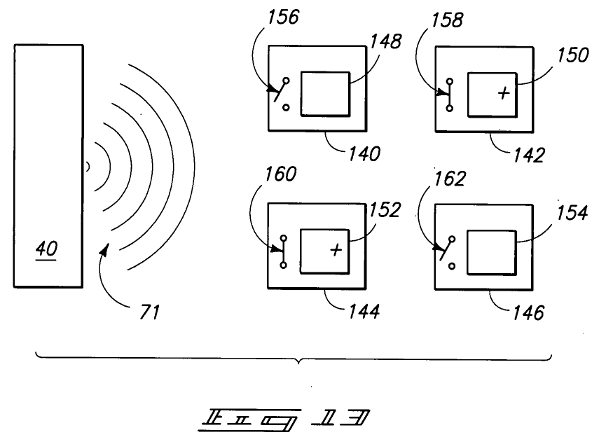

FIG. 12 depicts an embodiment of RFID 120 including the antenna 114 and observable indicator 12 of FIG. 1, a manually operated switch 116, communication circuitry 121, and indication circuitry 122.

Communication circuitry 121 is configured to receive a signal and indication circuitry 122 is configured to activate observable indicator 12 in response to communication circuitry 121 receiving the signal, but only if the manually operated switch is in the enabled position.

Manually operated switch 116 may be a manually operated momentary switch, a manually operated push-push switch, a manually operated toggle switch, or any other switch having an enabled position and a non-enabled position. Manually operated switch 116 is manually operated in that a physical input, such as a physical movement of physical touch, changes the position of the manually operated switch.

Communication circuitry 121 selectively enables indication circuitry 122 upon receiving a signal. For example, the communication circuitry 121 may selectively enable the indication circuitry 122 upon receiving an interrogation signal. In this case, a forward link of a radio connection may be verified since RFID 120 has correctly received the interrogation signal on the forward link.

If the signal is an interrogation signal, however, the return link may not by verified since communication circuitry 121 may enable indication circuitry 122 whether or not the interrogator successfully receives a reply signal from RFID 120.

The signal may also be an interrogation signal addressed exclusively to RFID 120. For example, a portion of the interrogation signal may include an identifier unique to RFID 120.

The signal may alternatively be an indicate signal, such as the indicate signal described above. As is described above in relation to FIG. 6, an interrogator may send the indicated signal in response to receiving a reply signal from the RFID, the reply signal being sent by the RFID in response to receiving an interrogation signal from the interrogator.

Communication circuitry 121 may receive a signal that is configured to enable indication circuitry 122 for a period of time. For example, as was described above, the signal may instruct communication circuitry 121 to enable indication circuitry 122 for a predetermined amount of time. Alternatively, communication circuitry 121 may receive an indicate signal and consequently enable indication circuitry 122 for a default period of time known by communication circuitry 121.

Communication circuitry 121 may also enable indication circuitry 122 during the period of time during which communication circuitry 121 is receiving a signal from the interrogator via antenna 14. For example, a passive RFID may use this low power scheme since the passive RFID has energy during the time when it is receiving a signal from the interrogator.

Indication circuitry 122 may activate observable indicator 12 when indication circuitry 122 has been enabled by communication circuitry 121 and manually operated switch 116 is in the enabled position. If manually operated switch 116 is in the non-enabled position, indication circuitry 122 may not activate observable indicator 12 even if indication circuitry 122 has been enabled by communication circuitry 121.

Indication circuitry 122 may activate observable indicator 12 using the methods described above in relation to FIG. 2. For example, indication circuitry 12 may provide a current to an LED.

FIG. 13 illustrates an indication system including an interrogator 40 and RFIDs 140, 142, 144, and 146 each having an observable indicator 148, 150, 152, and 154. Each of the RFIDs also has a manually operated switch 156, 158, 160, and 162. For purposes of illustration, all four RFIDs are within a range of interrogator 40.

Interrogator 40 sends a signal via a radio connection 71 to RFIDs 140, 142, 144, and 146. The signal is configured to activate observable indicators 148, 150, 152, and 154 for a period of time. Consequently, the RFIDs with a manually operated switch in the enabled position may activate their observable indicators.

FIG. 13 depicts RFIDs 142 and 144 as having manually operated switches 158 and 160 in an enabled position. As a result, observable indicators 150 and 152 are both activated as indicated by their plus signs. In contrast, RFIDs 140 and 146 have manually operated switches 156 and 162 that are in a non-enabled position. As a result, observable indicators 148 and 154 are note activated. Since all four of the RFIDs are within the range of the interrogator, if manually operated switch 156 or 162 were to be moved to an enabled position, the respective observable indicator, 148 or 154, would be activated.

In compliance with the statue, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

I/We claim:

1. A method of indicating bi-direction functionality of a radio connection, comprising:
transmitting an interrogation signal on a forward link of the radio connection;
receiving, from an RFID comprising an observable indicator, a reply signal on a return link of the radio connection responsive to the interrogation signal, the reply signal being configured to identify the RFID; and
sending an indicate signal to the RFID on the forward link responsive to the reply signal, the indicate signal being configured to instruct the RFID to activate the observable indicator effective to indicate bi-directional functionality of the radio connection.

2. The method of claim 1 further comprising sending a discontinue indicate signal to the RFID on the forward link a predetermined amount of time after sending the indicate signal, the discontinue indicate signal being configured to instruct the RFID to deactivate the observable indicator.

3. The method of claim 1 wherein transmitting an interrogation signal comprises transmitting an interrogation signal comprising a tag identifier exclusively identifying RFID.

4. The method of claim 1 wherein transmitting an interrogation signal comprises transmitting an interrogation signal comprising a tag identifier identifying a plurality RFIDs, the RFID being one of the plurality.

5. The method of claim 1 wherein sending an indicate signal comprises sending an indicate signal configured to instruct the RFID to activate the observable indicator for a predetermined amount of time.

6. The method of claim 1 wherein sending an indicate signal comprises sending an indicate signal configured to instruct the RFID to activate the observable indicator for a predetermined period of time specified by a portion of the indicate signal, after which the RFID de-activates the observable indicator.

7. An RFID, comprising:
an observable indicator;
indication circuitry configured to selectively activate the observable indicator; and
communication circuitry configured to:
send a reply signal via a radio connection in response to an interrogation signal received via the radio connection;
receive an indicate signal sent by an interrogation in response to the reply signal; and
enable the indication circuitry to activate the observable indicator after receiving the indicate signal.

8. The RFID of claim 7 wherein the observable indicator comprises a visually observable indicator.

9. The RFID of claim 7 wherein RFID is configured to receive the interrogation signal on a forward link of the radio connection via a continuous wave signal and send the reply signal on a return link of the radio connection by backscatter modulating the continuous wave signal.

10. The RFID of claim 7 wherein the reply signal comprises indicia identifying the RFID.

11. The RFID of claim 7 wherein the RFID is a passive RFID.

12. The RFID of claim 7 wherein the RFID is an active RFID.

13. An interrogator, comprising:
at least one antenna configured to send and receive signals via a radio connection; and
communication circuitry configured to:
transmit an interrogation signal via the radio connection to an RFID, the RFID comprising an observable indicator configured to selectively indicate bi-directional functionality of the radio connection,
receive a reply signal sent by the RFID via the radio connection in response to the interrogation signal; and
send via the radio connection an indicate signal configured to instruct the RFID to activate the observable indicator in response to receiving the reply signal.

14. An indication system, comprising:
an interrogator; and
an RFID configured to:
send a reply signal via a radio connection in response to an interrogation signal received via the radio connection from the interrogator;
receive an indicate signal sent by the interrogator in response to the reply signal; and
activate an observable indicator after receiving the indicate signal.

15. The system of claim 14 wherein the RFID comprises a passive RFID.

16. The system of claim 14 wherein the RFID comprises an active RFID.

17. The system of claim 14 wherein the observable indicator comprises a visually observable indicator.

18. An indication system, comprising:
an RFID configured to selectively indicate bi-directional functionality of a radio connection via an observable indicator; and
an interrogator configured to:
transmit, on the radio connection, and interrogation signal to the RFID;
receive a reply signal sent by the RFID in response to the interrogation signal via the radio connection; and
send an indicate signal configured to instruct the RFID to activate the observable indicator in response to the reply signal.

19. A method of determining a bi-directional communication range of an interrogator, comprising:
providing an RFID comprising an observable indicator;
placing the RFID in a plurality of locations; and
while the RFID is in each location:
transmitting an interrogation signal using the interrogator;
if the interrogator receives a reply signal from the RFID in response to the interrogation signal, sending an indicate signal to the RFID;
activating the observable indicator if the indicate signal is received by the RFID;
classifying the location as within the range if the observable indicator is activated at the location due to the indicate signal; and
classifying the location as outside the range is the observable indicator is not activated at the location.

20. The method of claim 19 wherein providing an RFID comprising an observable indicator comprises providing an RFID comprising an visually observable indicator.

21. The method of claim 19 wherein transmitting an interrogation signal comprises transmitting an interrogation signal comprising a tag identifier exclusively identifying the RFID.

22. A method of determining a bi-directional communication range of an interrogator, comprising:
providing a plurality of RFIDs, each RFID comprising an observable indicator;
placing each RFID in a different location;
transmitting an interrogation signal using the interrogator;
sending one or more indicate signals to those RFIDs of the plurality from which the interrogator receives a reply signal in response to the interrogation signal;
activating the observable indicators of those RFIDs of the plurality that receive one of the indicate signals; and
classifying the bi-directional communication range by identifying those RFIDs of the plurality with an activated observable indicator as within the bi-directional communication range and those RFIDs of the plurality with a de-activated observable indicator as outside the bi-directional communication range.

23. The method of claim 22 wherein providing a plurality of RFIDs comprises providing a plurality of active RFIDs.

24. The method of claim 22 wherein providing a plurality of RFIDs comprises providing a plurality of passive RFIDs.

25. The method of claim 22 wherein transmitting an interrogation signal comprises transmitting an interrogation signal comprising a tag identifier identifying the plurality of RFIDs.

26. The method of claim 22 wherein sending one or more indicate signals comprises sending one or more indicate signals, each indicate signal being exclusively addressed to one RFID of the plurality.

27. The method of 22 further comprising:
re-assessing the bi-directional communication range after an environment surrounding the interrogator has changed such that propagation of signals transmitted by the interrogator subsequent to the environment change will be affected by the environment change by:
transmitting an additional interrogation signal using the interrogator;
sending one or more additional indicate signals configured to activate the observable indicators of those RFIDs of the plurality from which the interrogator receives a reply signal in response to the additional interrogation signal; and
re-assessing the bi-directional communication range by identifying those RFIDs of the plurality with an activated observable indicator resulting from the additional indicate signals as within the bi-directional communication range and those RFIDs of the plurality with a de-activated observable indicator resulting from the additional indicate signals as outside the bi-directional communication range.

28. A method of activating an observable indicator, comprising:
providing an RFID comprising the observable indicator and a manually operated switch configured to switch between an enabled position and non-enabled position;
receiving a signal at the RFID, the signal being configured to activate the observable indicator for a period of time; and
activating the observable indicator for portions of the period of time during which the manually operated switch is in the enabled position.

29. The method of claim 28 wherein providing an RFID comprising a manually operated switch comprises providing an RFID comprising one of a manually operated momentary switch, a manually operated push-push switch, and a manually operated toggle switch.

30. The method of claim 28 wherein providing an RFID comprising the observable indicator comprises providing an RFID comprising a visually observable indicator.

31. The method of claim 28 wherein providing an RFID comprises providing a passive RFID.

32. The method of claim 28 wherein providing an RFID comprises providing an active RFID.

33. The method of claim 28 wherein receiving a signal at the RFID comprises receiving an interrogation signal at the RFID.

34. The method of claim 28 wherein receiving a signal at the RFID comprises receiving an interrogation signal addressed exclusively to the RFID at the RFID.

35. The method of claim 28 wherein receiving a signal at the RFID comprises receiving an indicate signal sent in response to a reply received from the RFID, the reply being sent by the RFID in response to an interrogation signal received by the RFID.

36. The method of claim 28 wherein when the manually operated switch is in the non-enabled position, the observable indicator cannot be activated.

37. The method of claim 28 wherein activating the observable indicator comprises powering a light-emitting diode.

38. An RFID, comprising:
an observable indicator;
a manually operated switch configured to switch between an enabled position and a non-enabled position;
communication circuitry configured to receive a signal; and
indication circuitry configured to activate the observable indicator in response to the communication circuitry receiving the signal only if the manually operated switch is in the enabled position.

39. The RFID of claim 38 wherein the observable indicator comprises a visually observable indicator.

40. The RFID of claim 38 wherein the observable indicator comprises a light-emitting diode.

41. The RFID of claim 38 wherein the manually operated switch comprises one of a momentary switch, a push-push switch, and a toggle switch.

42. The RFID of claim 38 wherein the communication circuitry is configured to receive the signal from an interrogator via a radio connection.

43. The RFID of claim 38 wherein the signal comprises an interrogation signal.

44. The RFID of claim 38 wherein the signal comprises an interrogation signal addressed exclusively to the RFID.

45. An indication system, comprising:
an interrogator configured to send a signal configured to activate an observable indicator for a period of time; and
an RFID comprising a manually operated switch configured to switch between an enabled position and a non-enabled position, the RFID being configured to activate the observable indicator upon receiving the signal from the interrogator for portions of the period of time during which the manually operated switch is in the enabled position.

46. The indication system of claim 45 wherein the interrogator sends the signal via a radio connection.

47. The indication system of claim 45 wherein the signal comprises an interrogation signal.

48. The indication system of claim 45 wherein the signal comprises an indicate signal addressed exclusively to the RFID.

49. The indication system of claim 45 wherein the manually operated switch comprises one of a momentary switch, a push-push switch, and a toggle switch.
